(19) United States
(12) Patent Application Publication
(10) Pub. No.: US 2020/0220720 A1
(43) Pub. Date: Jul. 9, 2020

(54) METHOD AND APPARATUS FOR CONTENT SECURITY, TRACKING AND USE VERIFICATION OVER A NETWORK

(71) Applicant: Crown Sterling Limited, LLC, Irvine, CA (US)

(72) Inventor: Joseph K. Hopkins, Ladera Ranch, CA (US)

(73) Assignee: Crown Sterling Limited, LLC, Irvine, CA (US)

(21) Appl. No.: 16/530,381

(22) Filed: Aug. 2, 2019

Related U.S. Application Data
(60) Provisional application No. 62/789,280, filed on Jan. 7, 2019.

(51) Int. Cl. H04L 9/08; H04L 29/06

(52) U.S. Cl. CPC H04L 9/0866; H04L 63/105; H04L 63/083

(57) ABSTRACT

The method and apparatus for content security, tracking and use verification over a network generates user specific, trackable token that is part of the user's identity and part of all content created by the user. The trackable token or footprint enables all of the user's content, including the details of their identity, to be controlled, verified and tracked by a compliance interface or console. The method and apparatus for content security, tracking and use verification requires any suitable form of user identity verification that generates an access key corresponding to the user's identity, biometric data and network activity. The user's access key will be a dynamic key that corresponds to each user and changes over time corresponding to their use and their network activities.

This application claims priority to U.S. Provisional Application 62/789,280, filed Jan. 7, 2019.

### FIELD OF THE INVENTIONS

The inventions described below relate to the field of content security, tracking and use verification over a network.

### BACKGROUND OF THE INVENTIONS

Many users on public and private networks create content and the users themselves represent valuable content as members of one or more demographics. This content has been monetized on networks such as the Internet by social media and other companies to the detriment of the users and the benefit of the companies.

A person's content, their personal identifiable information (PII), along with their intellectual property such as comments, documents, texts, e-mails, visual content, graphics, photographs, video and the like are often uploaded or “posted” to various locations or networks or servers by the user or captured by the site. A user's content posted on social media sites and other network public forums (such as Baidu Tieba, Facebook and its associated Facebook Messenger, Google+, Myspace, Instagram, LinkedIn, Pinterest, Snapchat, Tumblr, Twitter, Viber, VK, WeChat, Weibo, WhatsApp, and Wikia) should be afforded privacy and data rights protection and intellectual property rights protection.

Increasingly state laws are requiring social media and other websites to give users clear and prominent notice and obtain their express consent before sharing their information beyond their privacy settings. However, many companies have demonstrated a willingness to ignore their user's preferences and consent. The social media and other network sites and platforms should be prevented from monetizing or disclosing a person's proprietary data and content to another party absent the user's express and informed consent.

### SUMMARY

The method and system for content security, tracking and use verification over a network generates a user specific, trackable token, code or footprint that is part of the user's identity and part of all content created by the user. The trackable token, code or footprint enables all of the user's content, including the details of their identity, to be controlled, verified and tracked by a compliance interface or console. The method and apparatus for content security, tracking and use verification requires any suitable form of user identity verification that generates an access key corresponding to the user's identity, biometric data and/or network activity. The user's access key will be a dynamic key that corresponds to each user and changes over time corresponding to their use and their network activities.

Alternatively, The method and system for content security, tracking and use verification over a network verifies the user's identity through an exchange of keys with a security server and using the user's identity and the user's network activity, generates a user specific, trackable token. The trackable token or footprint enables all of the user's content, including the details of their identity, to be controlled, verified and tracked by a compliance interface or console. The method and apparatus for content security, tracking and use verification requires any suitable form of user identity verification that generates an access key corresponding to the user's identity, biometric data and/or network activity. The user's access key will be a dynamic key that corresponds to each user and changes over time corresponding to their use and their network activities.

### BRIEF DESCRIPTION OF THE DRAWINGS

FIG. 1 is a block diagram of a network for implementing the method and system for content security, tracking and use verification over a network.

FIG. 2 is a block diagram of the system of FIG. 1 adapted to use a network security method to implement content security, tracking and use verification over a network.

### DETAILED DESCRIPTION OF THE INVENTIONS

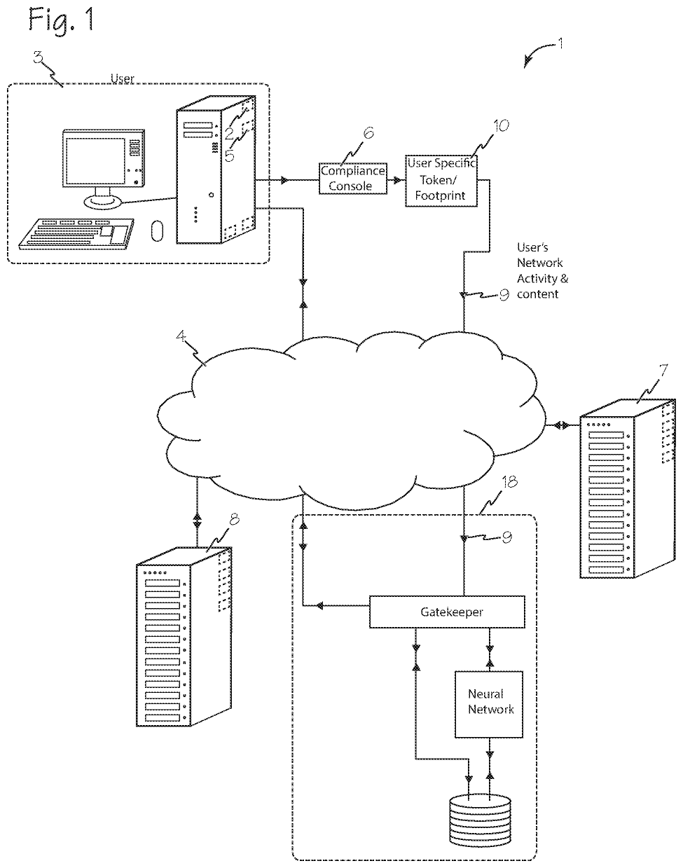

FIG. 1 is a block diagram of a network 1 for implementing the method and apparatus for content security, tracking and use verification over a network. Any suitable network security and identity verification application 2 operates on any suitable user's computing device such as user's computer system 3 connected to network 4.

A suitable security and identity verification system is disclosed in my copending U.S. patent application Hopkins, Method and Apparatus for Network Security and Identity Verification, U.S. patent application Ser. No. 16/520,059 filed Jul. 23, 2019 which is hereby expressly incorporated herein by reference in its entirety.

Once a user has had their identity verified by a suitable security and identity verification system, the user's content security, tracking and use verification application 5 will initiate the user's compliance interface or console 6 interacting with security server 18 to enable the user to set the level of compliance they want to be implemented by any domains (such as domains 7 and 8) they access through the network. The content security, tracking and use verification application 5 will control, catalog and track any user data such as the user's identity, sites (ie. uniform resource locaters (URLs)) visited, content viewed and personal characteristics, any content uploaded by the user such as text, documents, video, audio or photographs and or any content created by the user online. For example a user may want to eliminate all unauthorized use of the user's identity and personal characteristics such as their age, income level, city of residence, gender as well as their browsing history, etc. in the relevant domains/sites/pages/URLs. The user may also want their network activity and content they uplink to a domain such as content 9 to be available only to view on the domain/site/page/URL on which it was posted by the user and not to be moved or copied for any other use. These settings can be controlled in the compliance console. The user's data, their identity, their personal characteristics, their network browsing habits and traits, content they upload, content they create online and anything else that is the property of the user is associated with a user specific token or footprint 10 that is integrated into all the user's data and content such that if any of the user's data or content is misappropriated the token or footprint is trackable and unambiguously identifiable and may be traced back to the user.

If a user is unable to verify their identity to the content security, tracking and use verification application 5, the user will not be able to have their data and or content marked and tracked by the application. The user may access the network and some or all the domains connected to it, however they will not benefit from the content security, tracking and use verification application 5 without identity verification through security server 18.

Anything suitable for a token/footprint may be used such as a new, and unused, data type for the user's data and content or embedded data such as International Press Telecommunications Council (IPTC) special instructions or metadata. Alternatively the token/footprint may be active software such as an agent for identifying and tracking data and content. If network domains, such as social media sites, cooperate with the content security, tracking and use verification application 5 either approach may be used to protect and track a user's data. If the network domains refuse to cooperate, the token/footprint will need to be active software such as an agent for identifying and tracking data and content.

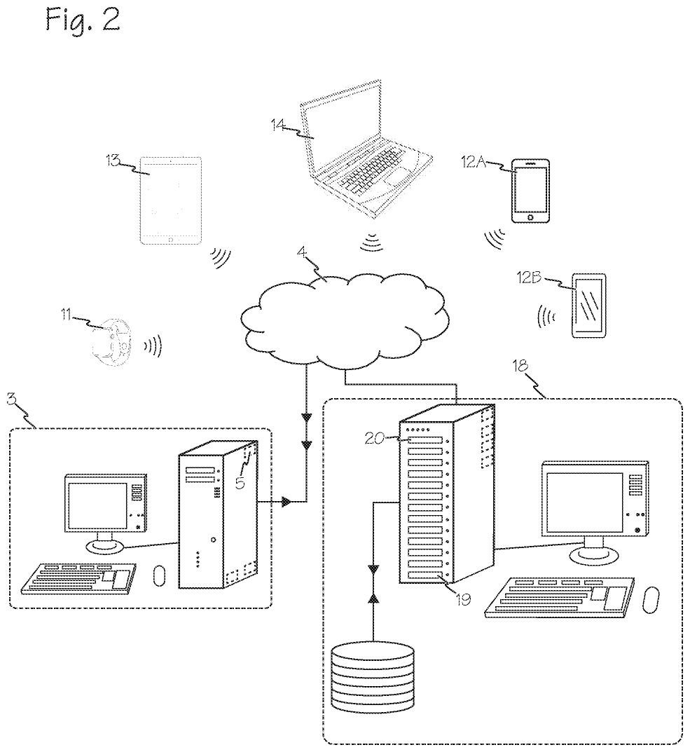

Referring now to FIG. 2, the method and apparatus for content security, tracking and use verification over a network may operate on any suitable user computing devices such as computer system 3, smart watch 11, smart phones 12, tablet 13 and computer 14. The user's security application 2 may connect to security server system 18 to enable the user to access a secure network or any suitable server or application on network 1 or any other network.

The user's token or footprint 10 is derived or created by the security server system 18 using any suitable number of elements such as the user's personal key, biometric key, digital signature and their dynamic key. Over time as the user interacts with a network 4 through the network security application the neural network 19 will modify/refine the user's behavioral pattern recognition learning from the compressed user network data and the activity dimensions. Once the dynamic pattern composition algorithm sends the activity dimensions to the gatekeeper/manager, the neural network acts as a kind of virtual brain and it is changed, learns, by the activity dimensions and it adds the activity dimensions to the database grouping system. This machine learning of the neutral network, capturing personalized attributes and patterns from the compressed thumbnail summaries and the activity dimensions, adds complexities to the authentication security of the security application.

Once a user gains access to the content security, tracking and use verification application 5, the user activates their compliance interface 6 which serves as an access portal to the network. A user accesses domains, sites and or pages on the network through the access portal of application 5. Any time a user uploads data to a network domain or interacts with the network domain in a way that would place any user identifiable data on the domain or anywhere else on the network the user's data is tagged, augmented or appended with the user's token or footprint 10. Whenever the user's tagged data or content is accessed, viewed or attempted to be used or manipulated in a manner contrary to the user's compliance settings, the source of the access attempt receives a notification from the user's compliance interface 6 that the data is not available for the desired access. If an unauthorized user circumvents the compliance interface and security settings, the presence of the user's token or footprint 10 makes it possible to follow, track, find and retrieve the misappropriated data across the network.

The user's compliance interface 6 shows (a) privacy rights, (b) intellectual property rights, (c) data and content usage allowance selection as controlled by users, (d) an indicator of the proper functioning of the compliance interface and (e) a gateway for data and content movement alerts displayed on the private secure compliance interface about each subscribed forum or domain on the network. The user's compliance interface or console connects to a secure site compliance console or interface to access a list of subscribed domains and other network forums, along with site compliance levels about data share allowance notification permissions as selected and controlled by users, and view and search captured known and unauthorized third party use of the user's data and content. As known and unauthorized third party data and content movement occurs, the user's compliance interface 6 serves as a gateway for data and content movement alerts to the user. These alerts may also be provided to the user via any suitable technique such as a text alert via a smartphone or other device.

As the neural network user pattern composition recognitions become mature, the security application is algorithmically programmed (based on the compiled compressed thumbnail summaries and the activity dimensions) to randomly select and apply a combination sequence of the last log of recorded occurrences of both local and Internet public forum activity dimensions. This combination sequence is a compounding effect that takes differing portions of each activity dimension component and applies any suitable mathematical formula to the neutral network output to complete the constitution of the user's dynamic key. The artificial intelligence interface significantly enhances the security of the platform.

An indicator of proper functioning of the compliance interface and data tracking may be any suitable feedback to the user that the compliance interface/tracking is active and functioning and their data is being protected and tracked, or that the interface is non-functional and their data is at risk of being misused. For example, the indicator may be a green icon if the compliance interface is functioning properly and a red icon if the compliance interface is non-functional.

While the preferred embodiments of the devices and methods have been described in reference to the environment in which they were developed, they are merely illustrative of the principles of the inventions. The elements of the various embodiments may be incorporated into each of the other species to obtain the benefits of those elements in combination with such other species, and the various beneficial features may be employed in embodiments alone or in combination with each other. Other embodiments and configurations may be devised without departing from the spirit of the inventions and the scope of the appended claims.

We claim:

1. A method for marking and tracking a user's data and content on a network comprising the steps:
capturing user biometric data corresponding to motion, orientation or pressure sensor data that characterizes the user's use of the computing device;
capturing user's device pattern recognition data consisting of at least one of the following:
measured speed, timing or pressure of keystrokes made by the user entering one or more preselected strings of characters;
creating a dynamic key using at least one of the following:
the user's device log data, data representing the user's network text entries, data representing the user's network image entries, compressed user network data and or weighted activity dimensions wherein the weighted activity dimensions include at least one selected from the following:
the number of friends associated with the user, the number of followers associated with the user, the number of other users linked to the user, the number of network sites visited by the user, a total of time spent on one or more preselected sites by the user, a total of time spent on one or more preselected network pages by the user, a numerical representation of content uploaded to the network by the user, a number representing the frequency of network usage by the user, a number representing the total duration of network usage by the user or the user's device log file;
incorporating the biometric data and the pattern recognition data with fixed user data into a personal key wherein the fixed user data is created using at least two selected from the following:
the user's full name, the user's mother's maiden name, the user's mother or father's city of birth, the user's city of birth, the user's date of birth, the user's day of birth and/or the user's birth gender;
encoding and sending the personal key to a security server;
decoding the personal key at the security server and comparing the personal key to a secondary personal key;
determining if the personal key and the secondary personal key correspond, if and only if they correspond, combining the personal key and the secondary personal key to form a composite key;
using the composite key to retrieve the dynamic key from the security server;
encoding and sending the composite key and the dynamic key to the computing device with an authentication verification;
setting a compliance level for the user's data and content corresponding to one or more domains on the network;
accessing one or more domains on the network; and
attaching trackable code corresponding to the set compliance level to the user's data and content on the one or more domains on the network.

2. The method of claim 1 wherein the trackable code is an active agent.

3. The method of claim 1 wherein the trackable code is passive code.

4. The method of claim 1 wherein the trackable code is a data type.

5. The method of claim 1 wherein the trackable code is metadata.

6. The method of claim 1 wherein the trackable code is embedded data.

7. The method of claim 1 further comprising the steps:
recording user data from the user's use of the network.

8. The method of claim 1 wherein if the personal key and the secondary personal key do not correspond, the user is prevented from setting a compliance level for the user's data and content and accessing one or more domains on the network.

9. The method of claim 7 wherein the user data is one of more selected from the following: user's identity, uniform resource locaters visited, content viewed, user personal characteristics, text content uploaded by the user, documents uploaded by the user, video uploaded by the user, audio uploaded by the user, photographs uploaded by the user or any content created by the user online.

10. A method for marking and tracking a user's data and content on a network corresponding an identity verification of the user comprising the steps:
verifying the user's identity;
setting a compliance level for the user's data and content corresponding to one or more domains on the network;
accessing one or more domains on the network corresponding to the user's identity; and
attaching trackable code corresponding to the set compliance level to the user's data and content on the one or more domains on the network.

11. The method of claim 10 wherein the trackable code is an active agent.

12. The method of claim 10 wherein the trackable code is passive code.

13. The method of claim 10 wherein the trackable code is a data type.

14. The method of claim 10 wherein the trackable code is metadata.

15. The method of claim 10 wherein the trackable code is embedded data.

16. The method of claim 10 further comprising the steps:
recording user data from the user's use of the network.

17. The method of claim 16 wherein the user data is one of more selected from the following: user's identity, uniform resource locaters visited, content viewed, user personal characteristics, text content uploaded by the user, documents uploaded by the user, video uploaded by the user, audio uploaded by the user, photographs uploaded by the user or any content created by the user online.

18. The method of claim 10 wherein the step of verifying the user's identity comprises the steps:
capturing user biometric data corresponding to motion, orientation or pressure sensor data that characterizes the user's use of the computing device;
capturing user's device pattern recognition data consisting of at least one of the following:
measured speed, timing or pressure of keystrokes made by the user entering one or more preselected strings of characters;
creating a dynamic key using at least one of the following:
the user's device log data, data representing the user's network text entries, data representing the user's network image entries, compressed user network data and or weighted activity dimensions wherein the weighted activity dimensions include at least one selected from the following:
the number of friends associated with the user, the number of followers associated with the user, the number of other users linked to the user, the number of network sites visited by the user, a total of time spent on one or more preselected sites by the user, a total of time spent on one or more preselected network pages by the user, a numerical representation of content uploaded to the network by the user, a number representing the frequency of network usage by the user, a number representing the total duration of network usage by the user or the user's device log file;
incorporating the biometric data and the pattern recognition data with fixed user data into a personal key wherein the fixed user data is created using at least two selected from the following:
the user's full name, the user's mother's maiden name, the user's mother or father's city of birth, the user's city of birth, the user's date of birth, the user's day of birth and/or the user's birth gender;
encoding and sending the personal key to a security server;
decoding the personal key at the security server and comparing the personal key to a secondary personal key;
determining if the personal key and the secondary personal key correspond, if and only if they correspond, combining the personal key and the secondary personal key to form a composite key;
using the composite key to retrieve the dynamic key from the security server; and
encoding and sending the composite key and the dynamic key to the computing device with an authentication verification.
